(19) United States
(12) Patent Application Publication
(10) Pub. No.: US 2006/0203972 A1
(43) Pub. Date: Sep. 14, 2006

(54) Method and system for audio program creation and assembly

(75) Inventor: Jeffrey Hays, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Equity Online Marketing, Inc., Sandy, UT (US)

(21) Appl. No.: 11/074,879

(22) Filed: Mar. 8, 2005

(51) Int. Cl. H04M 1/64

(52) U.S. Cl. 379/67.1

(57) ABSTRACT

A method and system for creating customized programs for individual requirements from a collection of prerecorded segments, which facilitates the creation of the program based on individual information and responses to specific inquiries to create a program which meets the interests, objectives and behavioral models appropriate to the user. This invention includes the capability of allowing the manual rearrangement and sequencing of the segments and produces a program, which is compatible with standard audio and multi-media players. This invention makes use of Internet connected devices to collect information and to distribute compiled programs.

### BACKGROUND OF INVENTION

1. Field of the Invention

This invention relates to methods and systems for the creation and assembly of customized, individualized audio programs. More specifically, this invention relates to the creation and assembly of audio programs using an on-line database.

2. Description of Related Art

A variety of techniques for assembling audio files have been proposed and are in use. Typically these techniques are either fully assembled without consideration of a specific individual user or are custom created by an individual for his or her own use or the use of a limited distribution of users. Neither of these processes provide for the creation and/or assembly of customized audio programs for individuals based on the receipt of individualized information and which makes use of a web-based data base of audio and user information to provide an efficient technique for the creation/assembly of audio programs for many users near simultaneously.

Although these referenced documents may not necessarily qualify as “prior art” to the present invention, the reader is referred to the following U.S. patent documents for general background material. Each of these documents is hereby incorporated by reference in its entirety for the material contained therein.

U.S. Pat. No. 6,311,155 B1 describes a method for providing multiple users with voice-to-remaining audio (VRA) adjustment capability.

U.S. Pat. No. 6,351,733 B1 describes a method and apparatus that enables the inclusion of voice and remaining audio information at different parts of the audio production process.

U.S. Pat. No. 6,408,315 B1 describes a system by which customized quality computer-based training (“CBT”) can be presented over a global network such as the Internet with low development costs, low hosting costs, inexpensive class production, and high-quality audio-visual content.

U.S. Pat. No. 6,458,060 B1 describes an exercise device that is configured to enable a user to interact with a trainer in real-time communication.

U.S. Pat. No. 6,529,584 B1 describes a navigable audio delivery system that includes an audio application and content.

U.S. Pat. No. 6,564,380 B1 describes an Internet-based video feed management system that controls, manages and administers the commercial distribution of live video feeds from on-site video cameras as well as other sources of video feeds to production companies at other locations.

U.S. Pat. No. 6,600,898 B1 describes a method and apparatus for generating a number audio element for playing a desired number in an audio system.

U.S. Pat. No. 6,640,145 B2 describes an intelligent media device, comprising a packet data communications interface; a media communication interface for receiving audio and/or video data; a digital memory for persistently storing received audio and/or video data; and an intelligent server for generating a virtual interface for controlling the media communication interface and the digital memory through said packet data communication interface and the digital memory through said packet data communications interface.

U.S. Pat. No. 6,641,523 B2 describes a method and apparatus for relaxing and reducing stress in an individual.

U.S. Pat. No. 6,658,062 B1 describes an information system that provides selected information to individual users.

U.S. Pat. No. 6,769,028 B1 describes a method for a computer system for sharing streaming media links.

U.S. Pat. No. 6,772,127 B2 describes a method and apparatus for including voice and remaining audio information at different parts of the audio production process.

U.S. Pat. No. 6,778,869 B2 describes a system and method for the request, delivery and use of multimedia files for audiovisual entertainment in the home environment.

U.S. Pat. No. 6,850,252 B1 describes an intelligent electronic appliance that preferably includes a user interface, data input and/or output port, and an intelligent processor.

### SUMMARY OF INVENTION

It is desirable to provide a method and system for creating individualized custom audio programs. Furthermore, it is particularly desirable to provide such a method and system, which makes use of the Internet and an on-line database for receiving individual information and for automatically compiling customized and individualized downloadable audio files and then providing the capability for downloading the compiled audio program.

Therefore, it is an object of one or more embodiments of this invention to provide a method and system that creates and assembles individual custom audio programs from audio files stored in an on-line accessible database.

It is another object of one or more embodiments of this invention to provide a method and system that creates and assembles individual custom audio programs that collects specific information from a user.

It is another object of one or more embodiments of this invention to provide a method and system that creates and assembles individual custom audio programs that creates a dynamic profile for the user.

It is another object of one or more embodiments of this invention to provide a method and system that creates and assembles individual custom audio programs that using a dynamic profile of a user assembles an audio file (program) from pre-recorded audio segments stored in an on-line database.

It is another object of one or more embodiments of this invention to provide a method and system that creates and assembles individual custom audio programs that provides the assembled audio file to the user for download to the user's audio playback device.

It is another object of one or more embodiments of this invention to provide a method and system that creates and assembles individual custom audio programs that provides the assembled audio file in a standard format for standard audio playback devices.

It is another object of one or more embodiments of this invention to provide a method and system that creates and assembles individual custom audio programs that provides for the receipt of updates to the user's individual profile by collecting additional, new or revised information from the user.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described several preferred embodiments of this invention, simply by way of illustration of modes of the invention suited to carry out this invention. As it will be realized, this invention is capable of other different embodiments, and its several details, steps, and specific features are capable of modification in various aspects without departing from the invention. Accordingly, the objects, drawings and descriptions should be regarded as illustrative in nature and not as restrictive.

### BRIEF DESCRIPTION OF DRAWINGS

The accompanying drawings incorporated in and forming a part of the specification, illustrate one or more preferred embodiments of the present invention. Some all, alternative embodiments are also described in the following description. In the drawings:

FIG. 1 is top-level process diagram of the top-level steps of the present embodiment of this invention.

FIG. 2 is a detailed system diagram of the present embodiment of this invention.

Reference will now be made in detail to the present preferred embodiment of this invention, an example of which is illustrated in the accompanying drawings.

### DETAILED DESCRIPTION

This invention is a method and system for creating customized individual downloadable audio files. Prior to this invention most if not all audio products were essentially presented to the end-user or customer in a fully completed form, without any interaction with this user. By taking advantage of the capabilities of the Internet, this invention provides a user with the opportunity to order and receive an audio program (or in some future envisioned embodiments a multi-media program) that has been assembled from constituent components to form a custom program particularly suited to the user's needs.

The following is a brief example of one possible application of the use of this invention. Many people enjoy bicycling on standard or stationary bicycles for recreation and exercise. Using this invention such a bicyclist would be able to receive a customized audio training coach program which would typically be downloaded from the user's personal computer to an audio player, such as an MP3 player or the like. The user can then carry this audio training coach program to the gym or road for a customized exercise experience. Typically, in this application, the user, using his or her own computer system and the Internet logs into a Destination Website. A series of questions are presented to the user online. For this application of the invention, the questions could be concern the user's current fitness level, distances the user is used to biking, time available for training, days the user can commit to training, short and long term goals and the like. These inquiries and gather information is presently accomplished by a processor managing a web site in communication with the Internet. Once this information has been received by the processor of this invention, which typically scores or correlates the received information, the processor accesses one or more media (multi-media or audio) databases and based on the scoring of the received information collects prerecorded segments stored in the databases. These prerecorded segments are then assembled into a custom individualized program. This custom program is the provided, via a media file download, to the user's computer. The user can then transfer the custom program from his or her computer to a typically portable audio or multi-media player, currently such as an IPOD or MP3 player, Personal Data Assistant (PDA) or the like. The present preferred embodiment of this invention also permits the user to create a report of the workout on his or her computer, this report can then be printed out and/or uploaded to the processor via the Destination Website to update the profile of the user created by the processor during the scoring step of the process. The prerecorded segments of this application of the invention may include such information as instruction, encouragement, historical anecdotes and the like, in other words coaching. Because this coaching program is customized to the user and because by varying the information provided to the processor the user can create a variety of individual personal and distinct programs. For example, the user can have workouts that are of different duration, intensity and difficulty. Other examples of the use of this invention to create customized individual programs would be other exercise routines such as running, weight lifting, rowing, walking or hiking and the like; entertainment programs, such as custom automatically selected programs of songs; motivational or meditational audio programs; educational study programs; and the like. Future envisioned embodiments of this invention will be able to create full multi-media programs, that could be displayed and played on such devices as next generation PDA's and digital cell phones and the like.

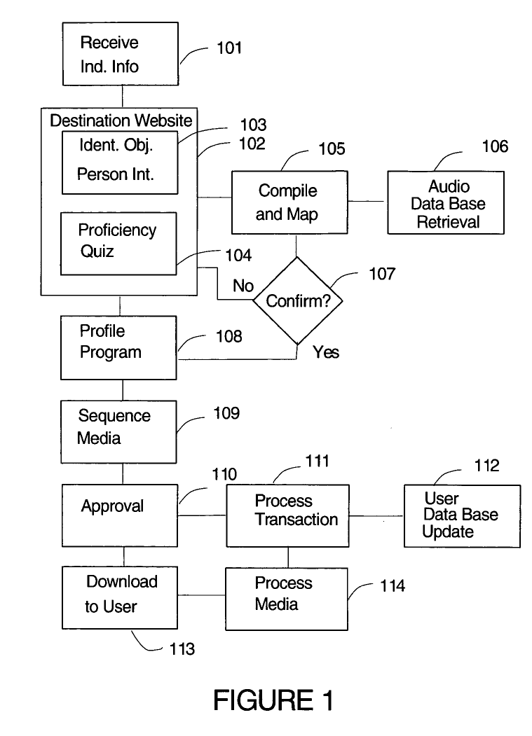

FIG. 1 shows top-level process diagram of the top-level steps of the present embodiment of this invention. The user typically begins the process by using his or her computer connected to the Internet to access the Destination Website 102. Once access has been accomplished, the processor through the Destination Website 102 receives 101 individual information from the user. This information will typically include such information as user identification and authorization information; program type, program objectives, user personal information, content of interest and then an authorization instruction to prepare the program. This information 103 is typically stored. A user quiz 104 is provided to collect and clarify with more specific information about the user relevant to the selected program, objectives and authority. The collected user information is then compiled 105. This compiler 105 constructs a customized program profile based on the interests, objectives and behavioral models as applied to the collected user information. This compiler 105 also maps the audio (or multi-media) files available for the selected authority and individual. The audio, or multi-media, segments are retrieved 106 from the audio database. The acceptability of the retrieved segments is confirmed 107. This confirmation may be done by the user in review the retrieved segments or alternatively may be done using an automated process based on the user's profile. If the segments are not confirmed, the user is redirected to input additional information 103 in the Destination Website 102. If the retrieved segments are acceptable, a program of the retrieved segments is created and presented 108 to the user. A sequencer 109 is provided to permit the user to custom sequence the program if desired. Once presented 108 and sequenced 109, the program is approved 110 and the transaction is processed 111 with the user's profile, account and history updated 112 to the user database. The resulting media files are processed 114 to place the program in the desired format and to prepare the program file for download. The resulting program file is downloaded 113 to the user's computer, typically over the Internet. The user can then at his or her convenience transfer the program file to the desired audio (or multi-media) player.

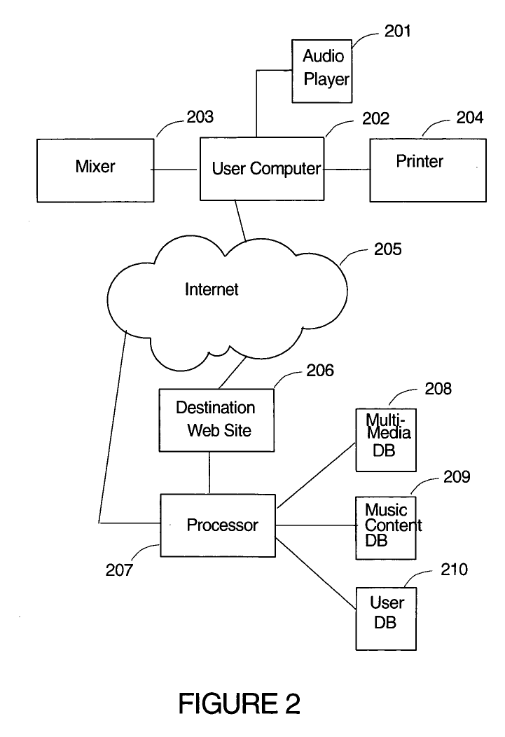

FIG. 2 shows a detailed system diagram of the present embodiment of this invention. This diagram shows the user's audio player 201 in communication with the user's computer 202 for receiving downloaded custom programs. The user's computer 202 in turn is in communication with a hard copy printer 204 for creating printed reports. A mixer 203, which may be either a hardware audio mixer or a software audio/multi-media processing package operating on the user's computer 202, is also show in communication with the user's computer. The user's computer 202 is shown in electronic communication with the Internet 205, where it 202 accesses the Destination Website 206. It is through the facility of the Destination Website 206 that the processor 207, executing the process of this invention, receives the customer information referred to above in the discussion of FIG. 1. The processor 207 in turn is in communication with one or more databases, for example: for storage of the multi-media content 208, music, audio or text content 209 and user information 210. The processor 207 is also connected to the Internet 205 to facilitate the transfer of the completed audio (or multi-media) program to the user's computer 202.

It is to be understood that the above described embodiments and examples are merely illustrative of numerous and varied other embodiments and applications which may constitute applications of the principles of the invention. These example embodiments are not intended to be exhaustive or to limit the invention to the precise form, connection or choice of components, computer language or modules disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is our intent that they be deemed to be within the scope of this invention, as determined by the appended claims when they are interpreted in accordance with the breadth to which they are fairly, legally and equitably entitled.

1. A process for creating individualized programs, comprising:
(A) receiving individual information from a user;
(B) quizzing a user for more specific information;
(C) compiling said individual information and said specific information to construct a program profile;
(D) retrieving one or more program segments from a database of prerecorded segments;
(E) creating a program of said retrieved one or more program segments;
(F) formatting said created program; and
(G) downloading said created to program to a user computer.

2. A process for creating individualized programs, as recited in claim 1, further comprising presenting said created program profile to a user.

3. A process for creating individualized programs, as recited in claim 1, further comprising mapping said program profile to said individual information.

4. A process for creating individualized programs, as recited in claim 1, further comprising processing a transaction.

5. A process for creating individualized programs, as recited in claim 1, further comprising processing said created program for download.

6. A process for creating individualized programs, as recited in claim 1, further comprising updating a user database.

7. A process for creating individualized programs, as recited in claim 1, wherein said programs are a collection of audio segments.

8. A process for creating individualized programs, as recited in claim 1, wherein said programs are a collection of multi-media segments.

9. A process for creating individualized programs, as recited in claim 1, wherein said individual information received is selected from the group consisting of: user identification and authorization information; program type, program objectives, user personal information, content of interest and an authorization instruction.

10. A process for creating individualized programs, as recited in claim 1, wherein said receiving individual information and quizzing a user for more specific information is accomplished with an Internet Destination Website accessed by a user's computer and which is in communication with a processor.

11. A process for creating individualized programs, as recited in claim 1, wherein said compiling further comprises constructing a customized program profile based upon said individual information, said specific information, user interests, user objectives and behavioral models.

12. A system for creating individualized programs, comprising:
(A) a destination web site accessible over the Internet;
(B) a processor connected to said Internet to receive information from said destination web site;
(C) one or more data bases connected to said processor and wherein at least one of said one or more databases is a storage medium for a collection of prerecorded segments;
(D) a user computer device connected to said Internet; and
(E) wherein said processor is configured to compile a program of said prerecorded segments.

13. A system for creating individualized programs, as recited in claim 12, wherein said information received by said processor includes individual information and specific information entered by a user.

14. A system for creating individualized programs, as recited in claim 12, wherein said prerecorded segments are audio files.

15. A system for creating individualized programs, as recited in claim 12, wherein said prerecorded segments are multi-media files.

16. A system for creating individualized programs, as recited in claim 12, wherein said processor compiles a program from said prerecorded segments based on said received information from said destination web site.

17. A system for creating individualized programs, as recited in claim 12, wherein said processor formats said program for download to said user computer device.

18. A system for creating individualized programs, as recited in claim 12, further comprising an audio player connectable to said user computer device and wherein said audio player is capable of producing an audio signal from a downloaded program.

19. A system for creating individualized programs, as recited in claim 12, further comprising a multi-media database connected to said processor.

20. A system for creating individualized programs, as recited in claim 12, further comprising a user database connected to said processor.
